(19) United States
(12) Patent Application Publication
(10) Pub. No.: US 2010/0180204 A1
(43) Pub. Date: Jul. 15, 2010

(54) SYSTEM AND METHOD FOR IMPORT AND EXPORT OF COLOR CUSTOMIZATION OF A DOCUMENT PROCESSING DEVICE

(76) Inventor: Alok MATHUR, Rancho Santa Margarita, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/352,726

(22) Filed: Jan. 13, 2009

(51) Int. Cl. G06F 3/00

(52) U.S. Cl. 715/744

(57) ABSTRACT

The subject application is directed to a system and method for customizing a device interface remotely by an administrator. The system includes a document processing device having an intelligent controller. A web server disposed on the controller is configured via a first web server configuration file to generate web output inclusive of indicia corresponding to operation of the document processing device. The web server receives selection data corresponding to a user-selected operation of the document processing device in accordance with generated indicia. A user interface with a thin client interfaces with the web server, generates a user interface inclusive of a display of the indicia, and generates the selection data in accordance with user input corresponding thereto. A data port outputs the configuration file to an associated administrative workstation and receives an alternative configuration file. A data editor loads a received alternative configuration file into the web server.

### BACKGROUND OF THE INVENTION

The subject application is directed generally to configuration or customization of document processing device interfaces. The application is particularly applicable to remote configuration or customization of device interfaces by an administrator.

Document processing devices in widespread usage included copiers, printers, facsimile machines, e-mail servers, and scanners. More recently, devices having two or more of these functions are being used in document processing environments, and they have become known as multifunction peripherals (MFPs) or multifunction devices (MFDs). Given the complexity and power of modern document processing devices, it is advantageous to incorporate a programmable, intelligent control system to operate a device, as well as to generate a user interface. Such control systems include a processor, memory and appropriate software, and is typically referred to as a controller.

Often it is desirable to alter or supplement device control features, particularly as reflected in a document processing device user interface. Such alterations are typically time consuming and difficult to implement, especially in environments where many such devices are installed and used.

### SUMMARY OF THE INVENTION

In accordance with one embodiment of the subject application, there is provided a system and method for remote customization of document processing device interfaces. A web server is operated on a document processing device controller having a processor and a data storage, and a first configuration file is stored in the data storage. A web output is generated inclusive of indicia corresponding to operation of the document processing device in accordance with the first configuration file and a user interface is generated on a thin client display of the document processing device inclusive of a display of the indicia. Selection data is received, via the web server, corresponding to a user-selected operation of the document processing device in accordance with generated indicia and the selection data is generated in accordance with received user input corresponding thereto via the user interface. The first configuration file is output to an associated administrative workstation, an alternative configuration file is received from the administrative workstation, and the received alternative configuration file is loaded into the web server so as to commence generation of an alternative user interface in accordance therewith.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for remote customization of a document processing device interface according to one embodiment of the subject application;

FIG. 2 is a block diagram illustrating device hardware for use in the system for remote customization of a document processing device interface according to one embodiment of the subject application;

FIG. 3 is a functional diagram illustrating the device for use in the system for remote customization of a document processing device interface according to one embodiment of the subject application;

FIG. 4 is a block diagram illustrating controller hardware for use in the system for remote customization of a document processing device interface according to one embodiment of the subject application;

FIG. 5 is a functional diagram illustrating the controller for use in the system for remote customization of a document processing device interface according to one embodiment of the subject application;

FIG. 6 is a hardware diagram of a suitable workstation for use in connection with the subject system according to one embodiment of the subject application;

FIG. 7 is a block diagram illustrating the system for remote customization of a document processing device interface according to one embodiment of the subject application;

FIG. 8 is a functional diagram illustrating the system for remote customization of a document processing device interface according to one embodiment of the subject application;

FIG. 9 is a flowchart illustrating a method for remote customization of a document processing device interface according to one embodiment of the subject application; and

FIG. 10 is a flowchart illustrating a method for remote customization of a document processing device interface according to one embodiment of the subject application.

### DETAILED DESCRIPTION OF THE PREFERRED EMBODIMENT

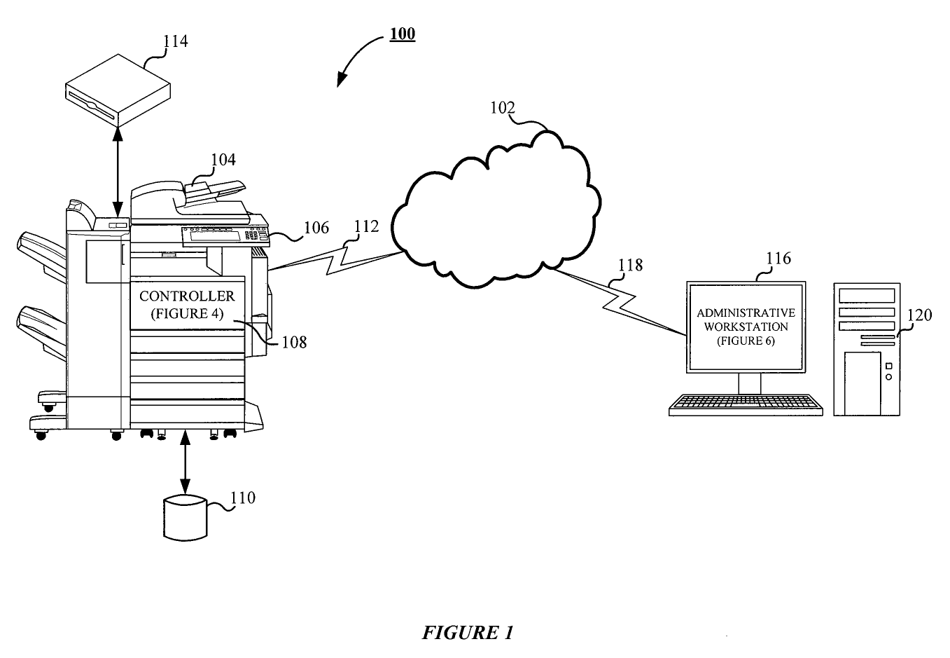

The subject application is directed to a system and method for customization of a document processing device interface. In particular, the subject application is directed to a system and method for remote configuration or customization of device interfaces by an administrator. It will become apparent to those skilled in the art that the system and method described herein are suitably adapted to a plurality of varying electronic fields employing remote interface customization including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for remote customization of a document processing device interface in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, which is depicted in FIG. 1 as a multifunction peripheral device suitably adapted to perform a variety of document rendering or processing operations. It will be appreciated by those skilled in the art that such document rendering operations include, for example and without limitation, facsimile, scanning, copying, printing, electronic mail, document management, document storage, or the like. Suitable commercially-available document processing devices include, for example and without limitation, the Toshiba e-Studio Series Controller. In accordance with one aspect of the subject application, the document processing device 104 is suitably adapted to provide remote document rendering or processing services to external or network devices. Preferably, the document processing device 104 includes hardware, software, or any suitable combination thereof configured to interact with an associated user, a networked device, or the like.

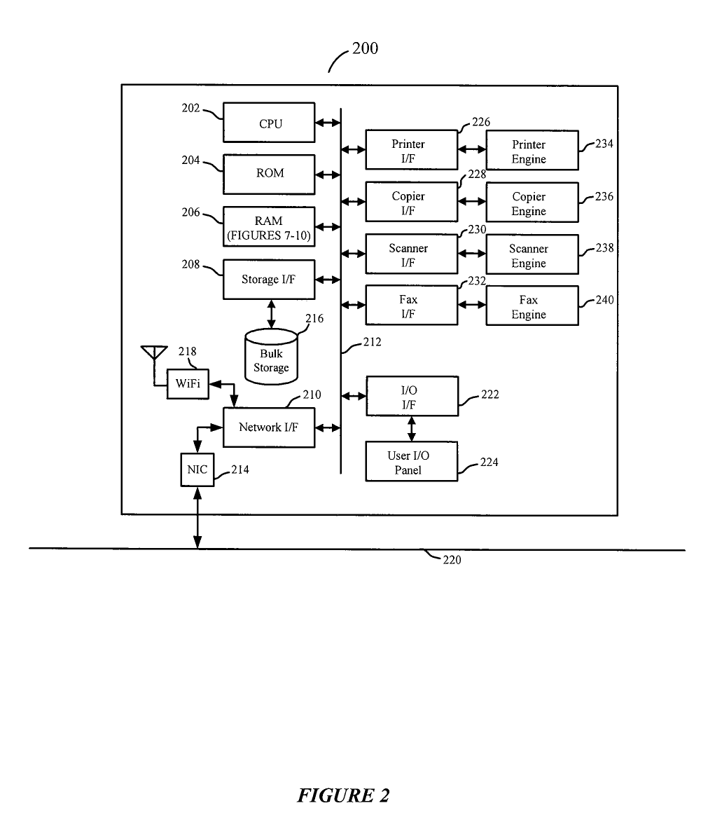

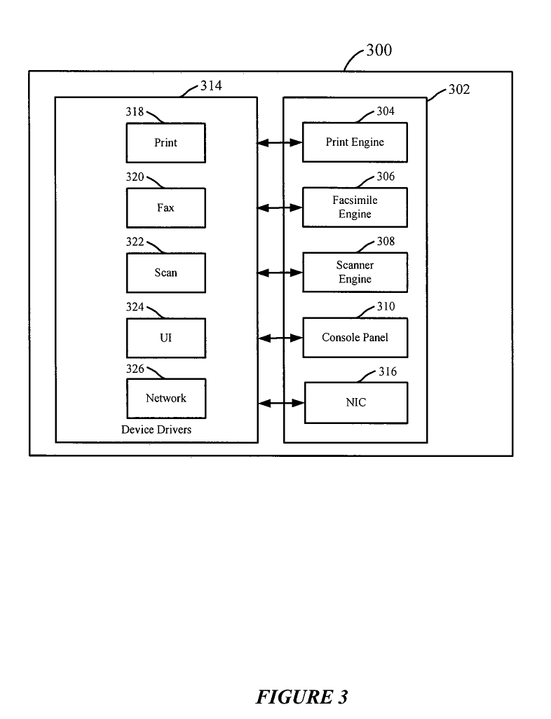

According to one embodiment of the subject application, the document processing device 104 is suitably equipped to receive a plurality of portable storage media including, without limitation, Firewire drive, USB drive, SD, MMC, XD, compact flash, memory stick, and the like. In the preferred embodiment of the subject application, the document processing device 104 further includes an associated user interface 106 such as a touch screen, LCD display, touch-panel, alpha-numeric keypad, or the like via which an associated user is able to interact directly with the document processing device 104. In accordance with the preferred embodiment of the subject application, the user interface 106 is advantageously used to communicate information to the associated user and to receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user; to receive input from the associated user; and to communicate the same to a backend component such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

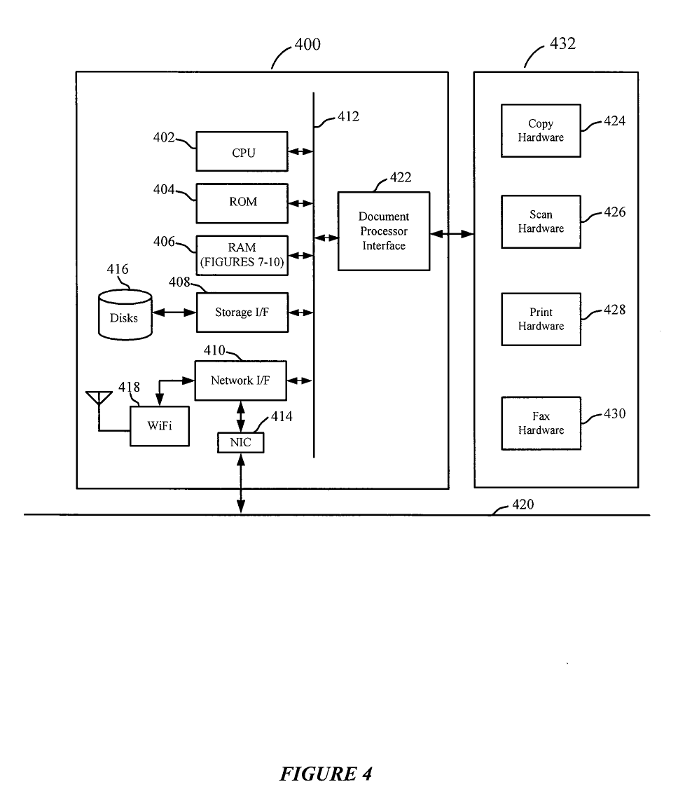

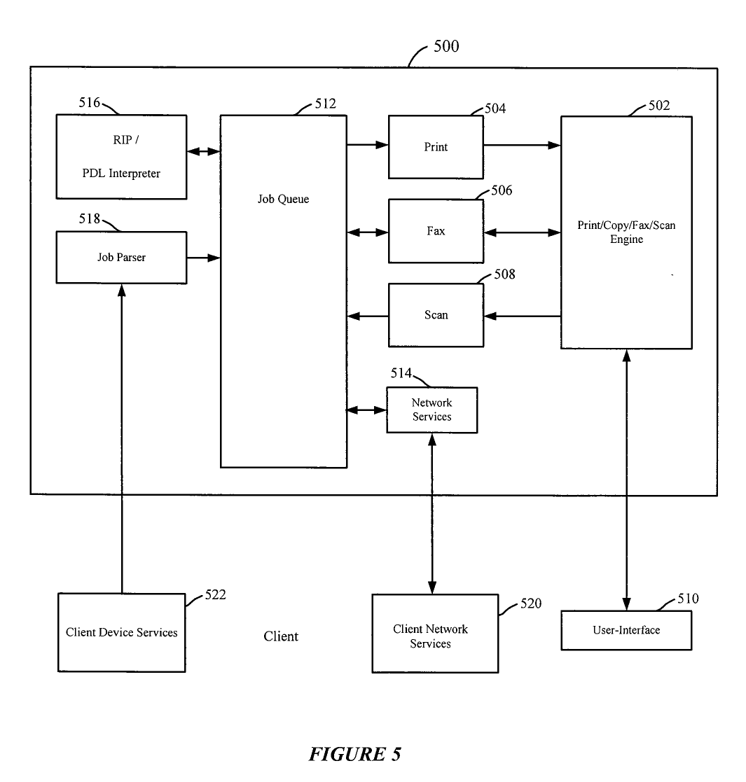

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, to facilitate the display of images via the user interface 106, to direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments that will be apparent to one skilled in the art are capable of employing the system and method for remote customization of a document processing device interface. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

The system 100 of FIG. 1 also includes a portable storage device reader 114 coupled to the document processing device 104 that is suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

Also illustrated in FIG. 1 is a portable storage device 114 that is capable of data communication with the document processing device 104. As will be appreciated by those skilled in the art, suitable portable storage devices include, for example and without limitation, radio frequency identification (RFID) card, smart card, magnetic storage card, employee badge flash drive, or the like. The skilled artisan will appreciate that other suitable portable storage devices are equally capable of implementation in accordance with the subject application. In accordance with one example embodiment of the subject application, the portable storage device 122 includes, for example and without limitation, configuration data for transport to and from a multi-function peripheral device and for transport to and from a workstation.

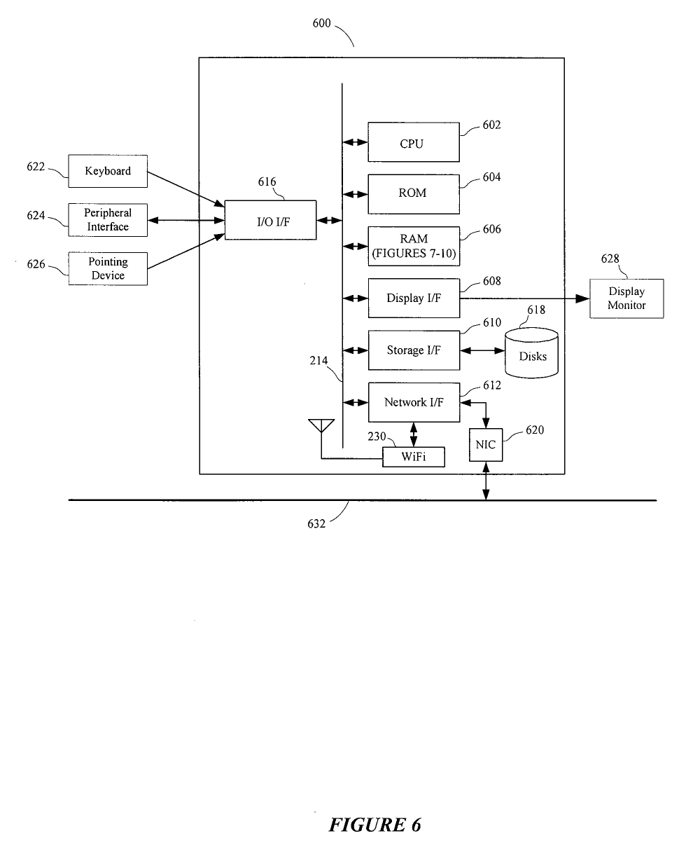

Depicted in FIG. 1 is an administrative device 116, illustrated as a personal computer in data communication with the computer network 102 via a communications link 118. It will be appreciated by those skilled in the art that the administrative device 116 is shown in FIG. 1 as a workstation computer for illustration purposes only. As will be understood by those skilled in the art, the administrative device 116 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 118 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. According to one embodiment of the subject application, the administrative device 116 further includes a suitable accounting system configured to monitor, track, and bill operations of the associated document processing device 104. In accordance with a further embodiment of the subject application, the administrative device 116 is capable of providing document data, user interface data, and/or image data; monitoring document processing jobs, user accounts, and/or billing information; employing thin-client interfaces; generating display data or output data; or the like with respect to the document processing device 104 or any other similar device coupled to the computer network 102. The function of the workstation will be understood in conjunction with the hardware diagram described hereinafter with respect to FIG. 6.

The system 100 of FIG. 1 also includes a portable storage device reader 120 coupled to the administrative device 116 that is suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

Turning now to FIG. 2, illustrated is a representative architecture of a suitable device 200, shown in FIG. 1 as the document processing device 104, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302 that facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316 with a network via driver 326 suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser 518 suitably functions to receive print job language files from an external device such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600 for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

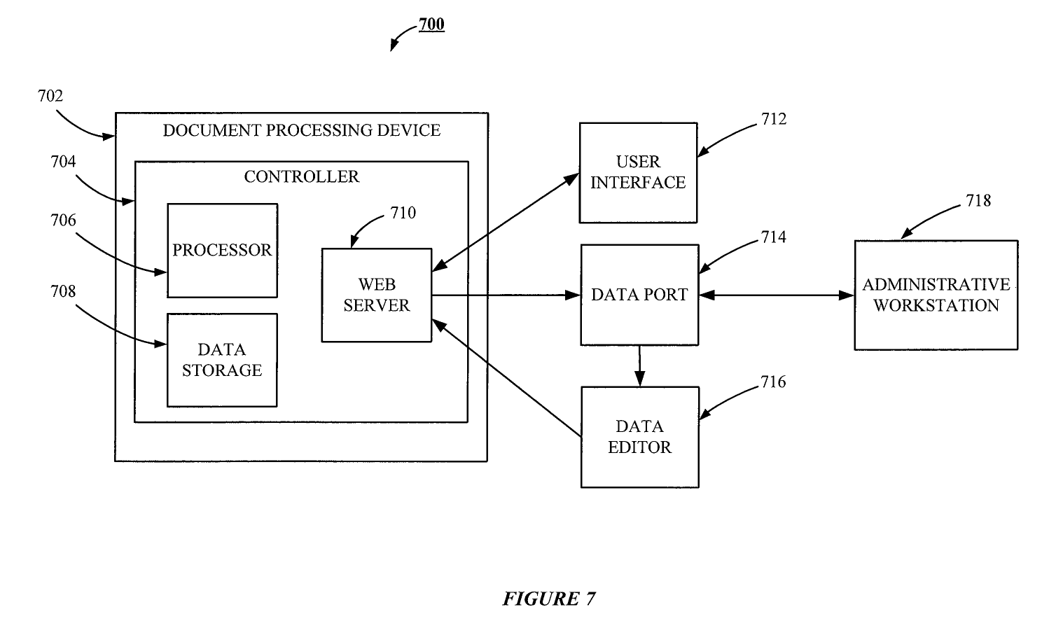

Turning now to FIG. 7, illustrated is a block diagram of a system 700 for remote customization of a document processing device interface in accordance with one embodiment of the subject application. The system 700 includes a document processing device 702 having an intelligent controller 704. The controller 704 has a processor 706 and a data storage 708. The system 700 also includes a web server 710, preferably disposed on the controller 706. The web server 710 is configured via a first web server configuration file to generate web output inclusive of indicia corresponding to operation of the document processing device 702. The web server 710 is further configured to receive selection data corresponding to a user-selected operation of the document processing device in accordance with generated indicia. The system 700 further includes a user interface 712 with a thin client operable to interface with the web server, and generate a user interface inclusive of a display of the indicia. The user interface 712 also generates the selection data in accordance with user input corresponding thereto. The system 700 further includes a data port 714 operable to output the configuration file to an associated administrative workstation 718. The data port 714 is further operable to receive an alternative configuration file from the administrative workstation 718. The system 700 has a data editor 716 operable to load a received alternative configuration file into the web server so as to commence generation of an alternative user interface in accordance therewith.

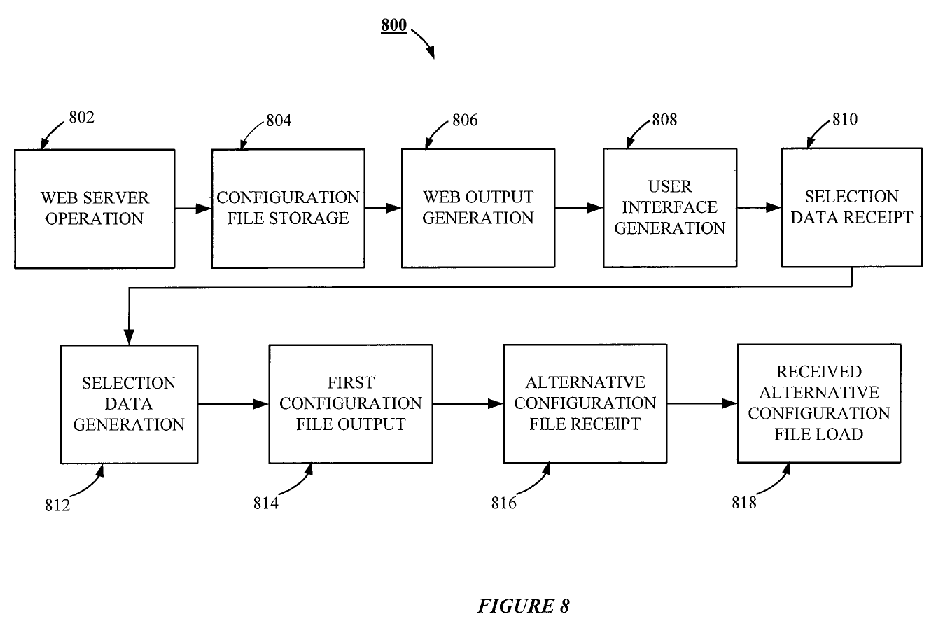

Referring now to FIG. 8, there is shown a functional diagram 800 illustrating the system for remote customization of a document processing device interface in accordance with one embodiment of the subject application. As shown in FIG. 8, first, web server operation 802 occurs on a document processing device controller having a processor and a data storage. Next, configuration file storage 804 occurs in the data storage. Web output generation 806 then occurs, inclusive of indicia corresponding to operation of the document processing device in accordance with the first configuration file. User interface generation 808 is then performed on a thin client display of the document processing device. Preferably, the user interface includes a display of the indicia. Selection data receipt 810 then occurs via the web server. Preferably, the selection data corresponds to a user-selected operation of the document processing device in accordance with generated indicia. Selection data generation 812 then occurs in accordance with received user input correspondence thereto via the user interface. First configuration file output 814 is then performed to an associated administrative workstation. Alternative configuration file receipt 816 from the administrative workstation then occurs. Received alternative configuration file load 818 is then performed into the web server so as to commence generation of an alternative user interface in accordance therewith.

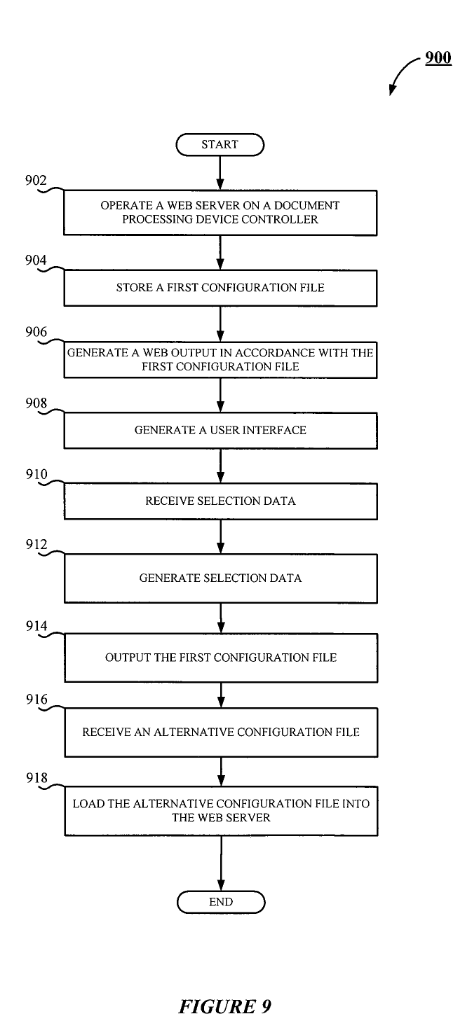

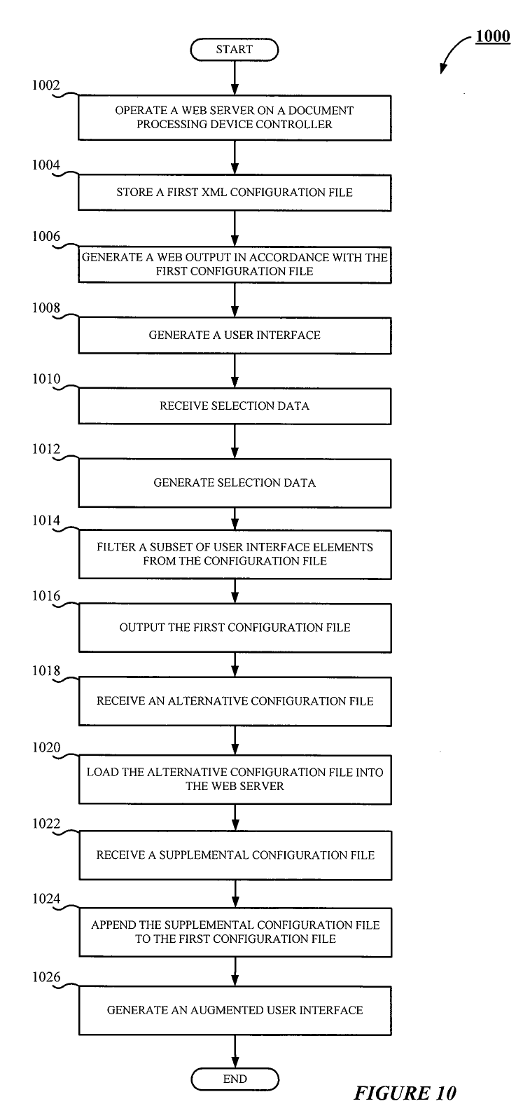

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a method for remote customization of a document processing device interface in accordance with one embodiment of the subject application. Beginning at step 902, a web server is operated on a document processing device controller 108 having a processor 402 and a data storage 416.

At step 904, a first configuration file is stored in the data storage 110. Then, at step 906, a web output is generated inclusive of indicia corresponding to operation of the document processing device in accordance with the first configuration file. At step 908, a user interface inclusive of a display of the indicia is generated on a thin client display, e.g. user interface 106, of the document processing device 104. At step 910, selection data corresponding to a user-selected operation of the document processing device 104 in accordance with generated indicia is received via the web server. The selection data is then generated at step 912 in accordance with received user input corresponding thereto via the user interface. At step, 914, the first configuration file is output to a suitable administrative workstation, e.g. administrative device 116. An alternative configuration file is then received at step 916 from the administrative workstation 116. At step 918, the received alternative configuration file is loaded into the web server so as to commence generation of an alternative user interface in accordance therewith.

Referring now to FIG. 10, there is shown a flowchart 1000 illustrating a method for remote customization of a document processing device interface in accordance with one embodiment of the subject application. The methodology of FIG. 10 begins at step 1002, whereupon a document processing device controller 108 having a processor 402 and a data storage 416 operates a web server. A first configuration file is then stored in the data storage 416 at step 1004. In one embodiment of the subject application, the configuration file is comprised of XML code including descriptors and icon files. It will be appreciated by one skilled in the art that these files may be compressed in an archive to create a single file or may be exported individually. The following is a an example descriptor file.

```
<LocalizationPack name=locale creationTime=time user=username>
    <SupportedFeatures>textual description</SupportedFeatures>
    <Messages>
        <Message id=identifier descriptor=textual description of string>
            <Locale=lang>string</Locale>
            ....
        </Message>
        ....
    </Messages>
    <Screens>
        <Screen id=identifier descriptor=textual description of UI>
            <Locale=country>path of xml</Locale>
            ....
        </Screen>
        ....
    </Screens>
    <Frames>
        <Frame id=identifier descriptor=textual description of UI>
            <Locale=country>path of xml</Locale>
            ....
        </Frame>
        ....
    </Frames>
    <Icons>
        <Icon id=identifier descriptor=textual description of icon>
            <Locale=language_country>path of icon</Locale>
            ....
        </Icon>
        ....
    </Icons>
</LocalizationPack>
```

At step 1006, a web output is generated in accordance with the first configuration file. Preferably, the web output includes indicia corresponding to operation of the document processing device 104. At step 1008, a user interface is generated on a thin client display of the document processing device 104. Preferably, the user interface includes a display of the indicia. Selection data corresponding to a user-selected operation of the document processing device 104 in accordance with generated indicia is then received via the web server at step 1010. At step 1012, the selection data is then generated in accordance with received user input corresponding thereto via the user interface. At step 1014, a subset of user interface elements is filtered from the configuration file. In one embodiment of the subject application, the user interface elements filtered are graphical user elements. In another embodiment of the subject application, the user elements filtered are device control elements.

The controller 108 or other suitable component associated with the document processing device 104 then outputs the first configuration file, at step 1016, to an associated administrative workstation 116. In one embodiment of the subject application, the configuration file is output via a network interface. In another embodiment of the subject application, the configuration file is output via a portable data storage interface to a portable storage device 114 such as a USB storage media device or the like. It will be appreciate by one skilled in the art that the administrative workstation 116 includes a customization tool such as a visual tool or the like for customizing the configuration file. An alternative configuration file is then received at step 1018 from the administrative workstation and is loaded into the web-server at step 1020 so as to commence generation of an alternative user interface in accordance therewith. A supplemental configuration file is received at step 1022 and appended to the first configuration file at step 1024. At step 1026, an augmented user interface is generated in accordance with the appended configuration file.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for remote customization of a document processing device interface comprising:
a document processing device including an intelligent controller having a processor and a data storage;
a web server disposed on the controller, the web server configured via a first web server configuration file to generate web output inclusive of indicia corresponding to operation of the document processing device, the web server further configured to receive selection data corresponding to a user-selected operation of the document processing device in accordance with generated indicia;
a user interface having a thin client operable to interface with the web server, and generate a user interface inclusive of a display of the indicia, and to generate the selection data in accordance with user input corresponding thereto;
a data port operable to output the configuration file to an associated administrative workstation, the data port further being operable to receive an alternative configuration file from the administrative workstation; and
a data editor operable to load a received alternative configuration file into the web server so as to commence generation of an alternative user interface in accordance therewith.

2. The system of claim 1 wherein the configuration file is comprised of XML code.

3. The system of claim 2 wherein the data port is comprised of at least one of a network interface and a portable data storage interface.

4. The system of claim 1 further comprising a filter operable to select a subset of user interface elements from the configuration file prior to output thereof via the data port.

5. The system of claim 4 wherein the filter is operable to select one of graphical user elements and device control elements from the configuration file.

6. The system of claim 1 wherein data port is further operable to receive a supplemental configuration file and wherein the data editor is further operable to append the supplemental configuration file to the first configuration file so as commence generation of an augmented user interface in accordance therewith.

7. A method for remote customization of a document processing device interface comprising the steps of:
operating a web server on a document processing device controller having a processor and a data storage;
storing a first configuration file in the data storage;
generating a web output inclusive of indicia corresponding to operation of the document processing device in accordance with the first configuration file;
generating on a thin client display of the document processing device, a user interface inclusive of a display of the indicia;
receiving, via the web server, selection data corresponding to a user-selected operation of the document processing device in accordance with generated indicia;
generating the selection data in accordance with received user input corresponding thereto via the user interface;
outputting the first configuration file to an associated administrative workstation;
receiving an alternative configuration file from the administrative workstation; and
loading the received alternative configuration file into the web server so as to commence generation of an alternative user interface in accordance therewith.

8. The method of claim 7 wherein the storing includes storing the configuration file comprised of XML code.

9. The method of claim 8 wherein the outputting includes outputting the first configuration file via at least one of network interface and a portable data storage interface.

10. The method of claim 7 further comprising the step of filtering a subset of user interface elements from the configuration file prior to output thereof.

11. The method of claim 10 wherein the filtering includes filtering one of graphical user elements and device control elements from the configuration file.

12. The method of claim 7 further comprising the steps of:
receiving a supplemental configuration file;
appending the supplemental configuration file to the first configuration file; and
generating of an augmented user interface in accordance with the appended configuration file.

13. A system for remote customization of a document processing device interface comprising:
means adapted for operating a web server on a document processing device controller having a processor and a data storage;
means adapted for storing a first configuration file in the data storage;
means adapted for generating a web output inclusive of indicia corresponding to operation of the document processing device in accordance with the first configuration file;
means adapted for generating on a thin client display of the document processing device, a user interface inclusive of a display of the indicia;
means adapted for receiving, via the web server, selection data corresponding to a user-selected operation of the document processing device in accordance with generated indicia;
means adapted for generating the selection data in accordance with received user input corresponding thereto via the user interface;
means adapted for outputting the first configuration file to an associated administrative workstation;
means adapted for receiving an alternative configuration file from the administrative workstation; and
means adapted for loading the received alternative configuration file into the web server so as to commence generation of an alternative user interface in accordance therewith.

14. The system of claim 13 wherein the means adapted for storing includes means adapted for storing the configuration file comprised of XML code.

15. The system of claim 14 wherein the means adapted for outputting includes means adapted for outputting the first configuration file via at least one of network interface and a portable data storage interface.

16. The system of claim 13 further comprising means adapted for filtering a subset of user interface elements from the configuration file prior to output thereof.

17. The system of claim 16 wherein the means adapted for filtering includes means adapted for filtering one of graphical user elements and device control elements from the configuration file.

18. The system of claim 13 further comprising:
means adapted for receiving a supplemental configuration file;
means adapted for appending the supplemental configuration file to the first configuration file; and
means adapted for generating of an augmented user interface in accordance with the appended configuration file.
